(19) United States
(12) Patent Application Publication
(10) Pub. No.: US 2013/0057670 A1
(43) Pub. Date: Mar. 7, 2013

(54) INFORMATION PROCESSING APPARATUS AND METHOD

(71) Applicant: Masatsugu Fukuda, Shizuoka-ken (JP)

(72) Inventor: Masatsugu Fukuda, Shizuoka-ken (JP)

(73) Assignee: TOSHIBA TEC KABUSHIKI KAISHA, Tokyo (JP)

(21) Appl. No.: 13/603,636

(22) Filed: Sep. 5, 2012

(30) Foreign Application Priority Data
Sep. 5, 2011 (JP) 2011-193213

(51) Int. Cl. H04N 7/18

(52) U.S. Cl. 348/77; 348/E07.085

(57) ABSTRACT

An information processing apparatus comprises a first imaging unit for imaging a commodity, a commodity recognition unit for comparing the imaged commodity image with a pre-stored commodity image, and recognizing the imaged commodity based on the similarity with the pre-stored commodity image, a second imaging unit for imaging the face of a customer, a member determining unit for comparing the imaged face image with a pre-stored face image of each member, and determining whether the customer imaged by the second imaging unit is a member based on the similarity with the face imaging of each member obtained by the comparison and a preference giving unit for giving the customer who is determined as a member by the member determining unit a given preference when the amount of each commodity recognized by the commodity recognition unit is counted.

### CROSS-REFERENCE TO RELATED APPLICATION

This application is based upon and claims the benefit of priority from Japanese Patent Application No. 2011-193213, filed Sep. 5, 2011, the entire contents of which are incorporated herein by reference.

### FIELD

Embodiments described herein relate to an information processing apparatus and a method.

### BACKGROUND

At present, a given preference is provided for registered members (customers) to promote sales in supermarkets and other shops. The preference of the registered members, for example, includes a point service using releasing points, in which corresponding points based on the transaction amount are given to the registered members and can be used for a reduction and so on in next transaction.

When a member registers, a membership card recording a member number and other inherent member identification information will be issued to each customer who wants to become a member at a shop side, and thus each member can be managed. For example, in the point service, the membership card storing the identification information of the member is issued to each member at the shop side, and thus the member is managed by making the association between the member identification information and points of each member. Moreover, when the amount of commodities is counted and so on, the member identification information stored within the membership card is read by a card reader apparatus and so on, and the points are specifically given to a member corresponding to the member identification information.

Moreover, previously, the customers are recognized based on the face images of the customers imaged by a imaging unit, and the stored purchase history record and other information associated with the recognized customers are prompted to an operator (salesperson) at the shop side.

### BRIEF DESCRIPTION OF THE DRAWINGS

FIG. 1 is a perspective view illustrating an example of a checkout system according to an embodiment;

FIG. 2 is a block diagram showing the components of hardware of a POS terminal and a commodity imaging apparatus;

FIG. 3 is a conceptual diagram showing the components of data of a PLU file.

FIG. 4 is a conceptual diagram showing the components of data of a member management file.

FIG. 5 is a block diagram showing the function components of a POS terminal and a commodity imaging apparatus;

FIG. 6 is a diagram illustrating an example of an receipt output by a POS terminal;

FIG. 7 is a flow chart showing an order of image output processing carried out by a commodity imaging apparatus;

FIG. 8 is a flow chart showing an order of sales registration processing carried out by a POS terminal;

FIG. 9 is a diagram illustrating other examples of components of the commodity imaging apparatus.

### DETAILED DESCRIPTION

According to one embodiment, an information processing apparatus comprises a first imaging unit configured to image a commodity as a purchased object, a commodity recognition unit configured to compare a first image imaged by the first imaging unit with a pre-stored commodity image of each commodity, and recognize the commodity imaged by the first imaging unit based on the similarity with the commodity imaging of each commodity obtained by the comparison, a second imaging unit configured to image the face of a customer who purchases the commodity, a member determining unit configured to compare a second image imaged by the second imaging unit with a pre-stored face image of each member, and determine whether the customer imaged by the second imaging unit is a member based on the similarity with the face imaging of each member obtained by the comparison and a preference giving unit configured to give the customer who is determined as a member by the member determining unit a given preference when the amount of each commodity recognized by the commodity recognition unit is counted.

The information processing apparatus and the method are described thereinafter according to the embodiment by taking a checkout system as an example. In addition, in the embodiment, the description is based on the application of an example of the checkout system in an eatery, a supermarket and other shops.

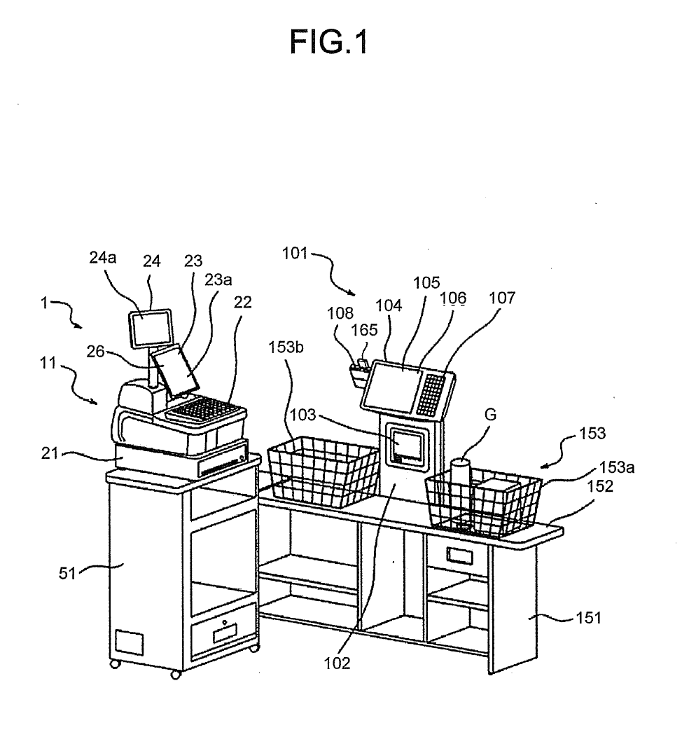

FIG. 1 is a perspective view illustrating an example of a checkout system according to an embodiment. As shown in FIG. 1, the checkout system 1 comprises a POS (Point Of Sale) terminal 11 and a commodity imaging apparatus 101.

The POS terminal 11 is configured on the upper surface of a cash drawer 21 on a checkout stand 51. The cash drawer 21 is controlled by the POS terminal 11 to be opened or closed. A keyboard 22 which is pushed down by an operator (salesperson) is configured on the upper surface of the POS terminal 11. It is seen from one side of the operator who operates the keyboard 22 that a display 23 for displaying information towards the operator is arranged at the innermost side of the keyboard 22 and displays the information on a display surface 23a thereof. A touch panel 26 is arranged on the display surface 23a in an overlapped way. A customer-oriented display 24 for displaying information on a display surface 24a thereof is rotatably, freely and vertically arranged at the further innermost side of the display 23. In addition, as shown in FIG. 1, the display surface 24a of the customer-oriented display 24 faces a near front side in FIG. 1, and can face an inner side in FIG. 1 by rotating the customer-oriented display 24, and the customer-oriented display 24 displays information towards the customer.

A Long-horizontal desk-shaped counter 151 is configured in a way that the counter 151 and the checkout stand 51 with the POS terminal 11 form an L shape, and a receiving surface 152 on which a shopping basket 153 for holding commodities G is formed on the counter 151. It takes into consideration that the shopping basket 153 comprises a first shopping basket 153a held by the customer, and a second shopping basket 153b configured at a position where the commodity imaging apparatus 101 is clamped by the first shopping basket 153a and the second shopping basket 153b. In addition, the shopping basket 153 is not limited to a basket shape, can also be a tray and the like. Moreover, the shopping basket 153 (second shopping basket 153b) is not limited to the basket shape, and can also be a carton, a shopping bag and the like.

The commodity imaging apparatus 101 which is connected with the POS terminal 11 by receiving and sending data is arranged on the receiving surface 152 of the counter 151, and comprises a thin rectangular housing 102 of which the front surface is provided with a reading window 103. A display operation unit 104 is arranged at the upper part of the housing 102, a display 106 is arranged on the display operation unit 104, and a touch panel 105 is arranged on the surface of the display 106 in an overlapped way. A keyboard 107 is arranged at the right of the display 106. It can be observed from an operator side that a customer-oriented display 108 for supplying information to the customer is arranged at the left inner side of the back of the display operation unit 104.

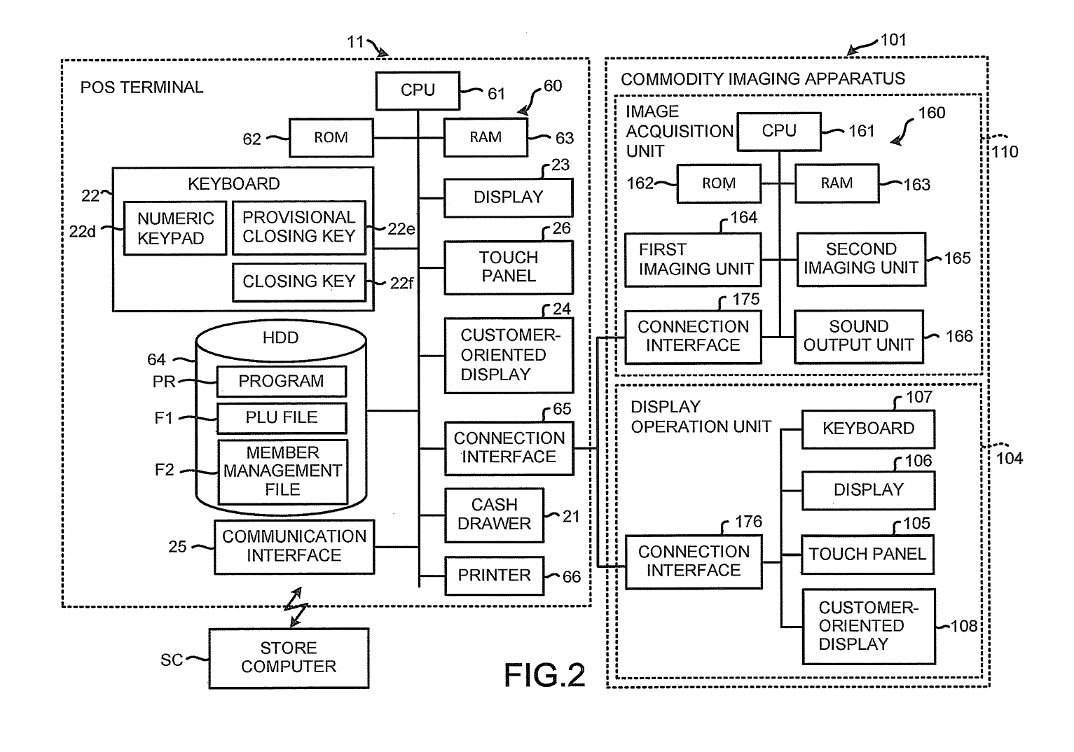

Moreover, the commodity imaging apparatus 101 comprises an image acquisition section 110 (refer to FIG. 2) which comprises a first imaging unit 164 (refer to FIG. 2) arranged at the inner side of the reading window 103, and a second imaging unit 165 arranged at the upper part of the customer-oriented display 108.

The first shopping basket 153a held by the customer holds the commodities G for one transaction. The commodities G in the first shopping basket 153a are manually moved to the second shopping basket 153b by an operator who operates the commodity imaging apparatus 101. In the movement process, the commodities face the reading window 103 of the commodity imaging apparatus 101. At the moment, the first imaging unit 164 (refer to FIG. 2) picks up the commodities G facing the reading window 103.

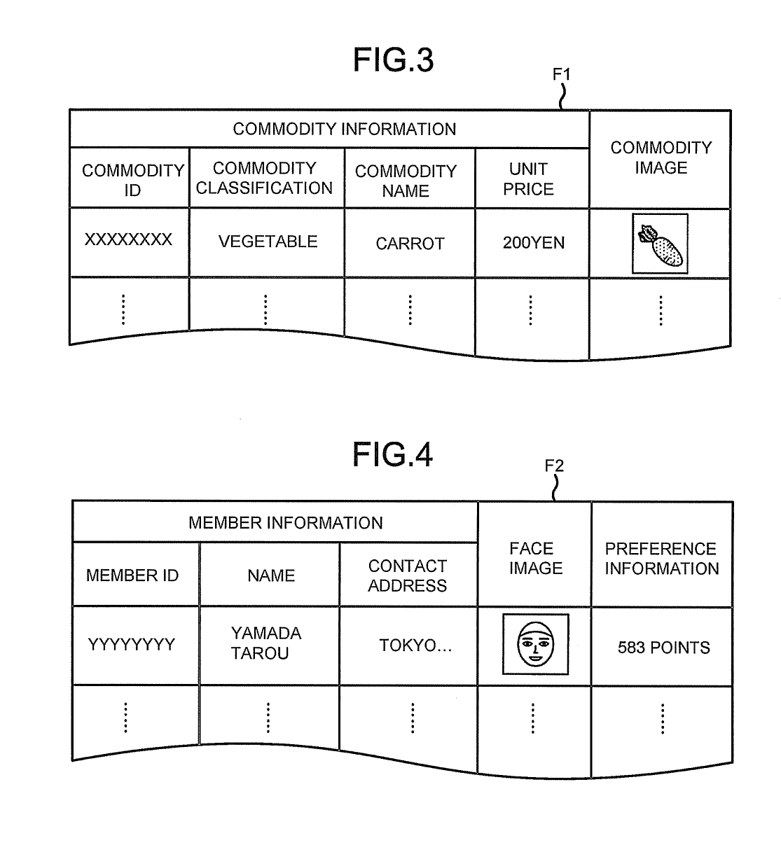

In the commodity imaging apparatus 101, all or part of the commodities G contained in images imaged by the first imaging unit 164 are detected. In the commodity imaging apparatus 101, under the condition that all or part of the commodities G contained in the images imaged by the first imaging unit 164 are detected, the imaged image as a commodity image is output to the POS terminal 11. In the POS terminal 11, by referring to a PLU (Price Look Up) filer F1 (refer to FIG. 3) in which the registered sales information of the commodities G are associated with the commodity images of the commodities G for each commodity G, according to the commodity images imaged by the first imaging unit 164 of the image acquisition section 110, the commodities G registered in the PLU file F1 are specified. And the commodity ID, the commodity price, the sales points and other registered sales information of the specified commodities G are recorded to a sales master file (not shown in Fig) for a sales registration by the POS terminal 11.

Moreover, a customer holding the first shopping basket 153a moves to the second shopping basket 153b in order to wait for the settlement at the POS terminal 11. The second imaging unit 165 picks up the face of the customer who moves to the second shopping basket 153b. In addition, in FIG. 1, the second imaging unit 165 is arranged at the upper part of the customer-oriented display 108, but the arrangement position has no special limitation as long as the face of the customer can be imaged, however, the second imaging unit 165 can also be arranged outside the commodity imaging apparatus 101.

In the commodity apparatus 101, the face of the customer contained in the image imaged by the second imaging unit 165 is detected. In the commodity apparatus 101, under the condition that the face image contained in the image imaged by the second imaging unit 165 is detected, the imaged image as the face image is output to the POS terminal 11. In the POS terminal 11, referring to a member management file F2 (refer to FIG. 4) in which the member ID specially distributed to each member, the name, the contact address and other member information of the member itself are associated with the face image of the member, the accumulated value of the points and other member preference information for each customer (hereinafter called a member) as a pre-registered member, the members registered in the member management file F2 are specified according to the face images imaged by the second imaging unit 165. And then, the points corresponding to the amount of the purchased commodities and other preferences are given to the specified members by the POS terminal 11.

FIG. 2 is a block diagram showing the components of hardware of a POS terminal 11 and a commodity imaging apparatus 101. The POS terminal 11 comprises a microcomputer 60 as an information processing unit for executing information processing. The microcomputer 60 is form by connecting ROM 62 (Read Only Memory) and RAM 63 (Random Access Memory) via buses on the CPU 61 (Central Processing Unit) for executing various algorithm processing and controlling each unit.

The cash drawer 21, the keyboard 22, the display 23, the touch panel 26 and the customer-oriented display 24 are connected onto the CPU 61 of the POS terminal 11 via various input and output circuits (not shown in Fig.). These components are controlled by the CPU 61.

The keyboard 22 comprises a numeric keypad 22d on the upper surface of which ‘1’, ‘2’, ‘3’, etc. and other numbers and operators such as ‘x’ are displayed, a provisional closing key 22e and a closing key 22f.

An HDD 64 (Hard Disk Drive) is connected onto the CPU 61 of the POS terminal 11. Programs and various files are stored in the HDD 64. All or part of the programs and various files stored in the HDD 64 are copied to the RAM 63 and are sequentially executed by the CPU 61 when the POS terminal 11 starts up. Hereupon, the programs stored in the HDD 64 are programs PR for commodity sales data processing, etc. And the files stored in the HDD 64 are the PLU file F1 and the member management file F2, etc.

The PLU file F1 is a file set by making the association between the registered sales information of the commodities G and the images of the commodities G for each commodity G displayed for sales in the shop.

FIG. 3 is a concept diagram showing the components of data of a PLU file F1. As shown in FIG. 3, the PLU file F1 is used for storing specially distributed commodity ID, commodity classification of the commodities G, the commodity name, the unit price image of the commodities imaged and other commodity images associated with the commodities for each commodity. Besides, the data components of the PLU file F1 are not limited to the example of FIG. 3, for example, the PLU file F1 can also be set by making the association between the following commodity-related characteristic quantities (color, surface state, etc.) read from the commodity images and the decision threshold value of similarity for each commodity.

The member management file F2 is a data file set by making the association between the member-related member information, the face image of the member, and the given preference-related preference information for each customer (member) as the registered member in the shop.

FIG. 4 is a conceptual diagram showing the components of data of a member management file. As shown in FIG. 4, the member management file F2 is used for storing the member ID specially distributed to each member, the member name, the contact address and other member-related member information, the imaged face image of the member, the accumulated value of the points, and other preference-related preference information given to the member for each member. And the data components of the member management file F2 are not limited to the example of FIG. 3, and can also be set by associating with other information.

Returning to FIG. 2, a communication interface 25 through which a store computer 201 is in data communication with a member registration terminal 301 is connected onto the CPU 61 of the POS terminal 11 via an input and output circuit (not shown in Fig.). Hereupon, the store computer 201 is arranged at the backyard of the shop, etc. The PLU file F1 and the member management file F2 which are sent to the POS terminal 11 are stored in the HDD (not shown in Fig.) of the store computer 201. Moreover, the member registration terminal 301 is configured on the service counter of the shop, etc. A file in which the face image input from the POS terminal 11 and the following transaction recognition information which are associated with each other are stored is stored in the HDD (not shown in Fig.) of the member registration terminal 301.

In addition, a connecting interface 65 which is connected with the commodity imaging apparatus 101 by receiving and sending data is connected onto the CPU 61 of the POS terminal 11. The commodity imaging apparatus 101 is connected onto the connecting interface 65. And a printer 66 for printing an receipt, etc. is connected onto the CPU 61 of the POS terminal 11. The one-transaction content is printed onto the voice by the POS terminal 11 based on the control of the CPU 61.

The commodity imaging apparatus 101 also comprises a microcomputer 160 which is formed by connecting the ROM 162 and the RAM 163 onto the CPU 161. The ROM 162 is used for storing a program executed by the CPU 161. The first imaging unit 164, the second imaging unit 165 and a sound output unit 166 are connected onto the CPU 161 via various input and output circuits (not shown in Fig.). The first imaging unit 164, the second imaging unit 165 and the sound output unit 166 are controlled to actuate by the CPU 161. The display operation unit 104 is connected with the image acquisition section 110 and the POS terminal 11 via the connecting interface 176, and is controlled to actuate by the CPU 161 of the image acquisition section 110 and the CPU 161 of the POS terminal 11.

The first imaging unit 164 and the second imaging unit 165 are a color CCD (Charge Coupled Apparatus) image sensor or a color COMS (Complementary Metal Oxide Semiconductor) image sensor, etc., and pick up images from the reading window 103 under the control of the CPU 161. For example, the first imaging unit 164 and the second imaging unit 165 pick up dynamic images at 30 fps (Frames Per Second). The images sequentially imaged at a given frame rate by the first imaging unit 164 and the second imaging unit 165 are stored in the RAM 163.

The sound output unit 166 is a sound circuit used for generating a preset warning sound, etc., and a speaker, etc., and reports with the warning sound, etc. under the control of the CPU 161.

In addition, a connecting interface 175 is connected onto the CPU 161 and is connected with a connecting interface 65 of the POS terminal 11, and data can be received and sent between the connecting interface 175 and the POS terminal 11. And the data can be received and sent between the CPU 161 and the display operation unit 104 via the connecting interface 175.

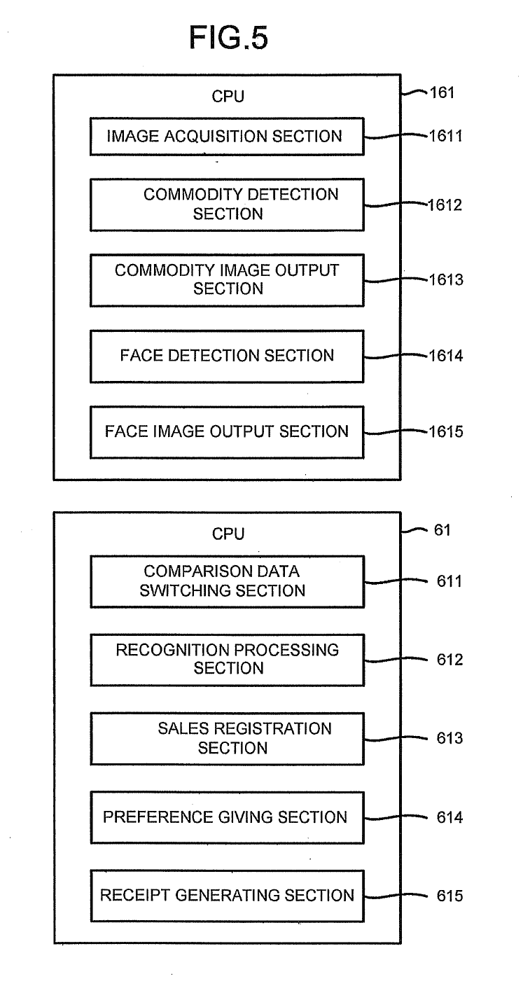

Next, the function units of the CPU 161 and the CPU 61 realized by the CPU 161 and the CPU 61 by sequentially executing programs are described in detail below with reference to FIG. 5.

FIG. 5 is a block diagram showing the function components of a POS terminal and a commodity imaging apparatus. As shown in FIG. 5, the CPU 161 of the commodity imaging apparatus 101 as an image acquisition section 1611, a commodity detection unit 1612, a similarity calculation unit 1613, a commodity candidate prompting unit 1614 and a registered commodity informing unit 1615 plays roles by sequentially executing the programs. Similarly, the CPU 61 of the POS terminal 11 as a comparison data switching unit 611, a recognition processing unit 612, a sale registration unit 613, a preference giving unit 614 and an receipt generating unit 615 play roles.

The image acquisition section 1611 outputs pickup turn-on signals to the first imaging unit 164 and the second imaging unit 165, so that the first imaging unit 164 and the second imaging unit 165 start to image. The image acquisition section 1611 sequentially acquires the images imaged by the first imaging unit 164 and then stored in the RAM 163 after the pickup action starts, and sequentially obtains the images imaged by the second imaging unit 165 and then stored in the RAM 163 after the pickup action starts. Hereinafter, the images imaged by the first imaging unit 164 are expressed as first images, and the images imaged by the second imaging unit 165 are expressed as second images. Besides, the image acquisition section 1611 acquires the first images and the second images in an order that the images are stored in the RAM 163.

The commodity detection unit 1612 detects all or part of images representing the commodities G in the first images acquired from the image acquisition section 1611 by a well-known pattern matching technology, etc. Specifically, outline lines are extracted from the binarized first images. And then, by comparing an outline line extracted from the nearest first image with the outline line extracted from the first image at this time, a changed part, i.e., the showing of the commodity facing the reading window 103, is detected.

Besides, as other methods for detecting commodities, whether there is a skin color area or not is detected according to the acquired frame image. And then, under the condition that the skin color area is detected, i.e., under the condition that the showing of the hand of a salesperson is detected, by detecting the outline line, an attempt to extract the outline of the commodity which is hypothetically held by the salesperson is made. At the moment, under the condition that the outline of the shape of the hand and other outlines are detected, the commodity is held by the salesperson, so the showing of the commodity is detected.

All or part of first images of the commodities G detected by the commodity detection unit 1612, which are used as commodity images, are output to the POS terminal 11 by the commodity image output unit 1613 via the connecting interface 175.

The face detection unit 1614 detects images representing the faces of the customers in the second images acquired from the image acquisition 1611 by a well-known pattern matching technology or face detection, etc. Specifically, the face detection unit 1614 detects the configuration positions such as the outline of the face, eyes, the mouth, and the nose from the acquired second images.

The second images of the faces detected by the face detection unit 1614, which are used as face images, are output to the POS terminal 11 by the face image output unit 1615 via the connecting interface 175. Besides, the commodity images, the face images and the image recognition information capable of recognizing image categories are output together to the POS terminal 11.

The comparison data switching unit 611 determines that the images input from the commodity imaging apparatus 101 are commodity images or face images, and switches comparison image data (hereinafter called comparison images) recognized and processed by the recognition processing unit 612 according to the determined results. Specifically, under the condition that the images input from the commodity imaging apparatus 101 are determined as commodity images by the comparison data switching unit 611, each commodity image stored in the PLU file F1 is set as a comparison image of the recognition processing unit 612. And under the condition that the images input from the commodity imaging apparatus 101 are determined as face images by the comparison data switching unit 611, each face image stored in the member management file F2 is set as a comparison image of the recognition processing unit 612.

The recognition processing unit 612 recognizes objects (commodity or customer) represented by the commodity images or face images by comparing the commodity images or face images input from the commodity imaging apparatus 101 with the comparison images set by the comparison data switching unit 611.

Specifically, the recognition processing unit 612 reads characteristic quantities such as the shape, the color, the configuration state of the color, etc. of the commodities G from the commodity images input by the commodity imaging apparatus 101. By comparing the characteristic quantities read from the commodity images by the recognition processing unit 612 with the characteristic quantities of each commodity image in the PLU file F1, which is set as a comparison image by the comparison data switching unit 611 according to the commodity images, the similarity between the commodity G and each commodity registered in the PLU file F1 is counted. Hereupon, the similarity means to what extent all or part of images of the commodities G are similar under the condition that the commodity images of commodities stored in the PLU file F1 are set to be 100%. For example, weighing can be also be added according to the classification of the characteristic quantities.

Moreover, the recognition processing unit 612 determines whether the calculated similarity for each commodity image in the PLU file F1 exceeds the preset threshold value or not, and recognizes (specifies) the commodities of the commodity images with the similarity exceeding the threshold value as the commodities G imaged by the first imaging unit 164 of the commodity imaging apparatus 101.

Besides, under the condition that the processing result of the recognition processing unit 612 is that there are many commodity images with the similarity exceeding the threshold value, these commodity images are displayed on the display 23 and thus are chosen by an operator at the POS terminal 11. And also, under the condition that the processing result of the recognition processing unit 612 is that there is no commodity image with the similarity exceeding the threshold value, a manually chosen commodity picture (graphical user interface) corresponding to the commodity G is displayed on the display 23, and thus is chosen by the operator at the POS terminal 11.

Moreover, the recognition processing unit 612 reads the configuration sate such as the face shape, the color, eyes, the nose, and the mouth of the customer as characteristic quantities in the face images input by the commodity imaging apparatus 101. By comparing the characteristic quantities read from the face images by the recognition processing unit 612 with the characteristic quantities of each face image in the member management file F2, which is set as a comparison image by the comparison data switching unit 611 according to the face image, the similarity between the face of the customer and the face image of each member registered in the member management file F2 is calculated. Hereupon, the similarity means to what extent the face images of the customers are similar under the condition that the face images of members stored in the member management file F2 are set to be 100%. For example, weighing can also be added according to the classification of the characteristic quantities.

Moreover, the recognition processing unit 612 determines whether the similarity calculated according to each face image in the member management file F2 exceeds the preset threshold value or not, and whether there is a member whose face image has the similarity exceeding the threshold value or not. Hereupon, under the condition that there are face images with the similarity exceeding the threshold value in the member management file F2, the recognition processing unit 612 recognizes the customers imaged by the second imaging unit 165 of the commodity imaging apparatus 101 as members whose face images with the similarity exceeding the threshold value. And under the condition that there is no face images with the similarity exceeding the threshold value in the member management file F2, the recognition processing unit 612 determines that the customers imaged by the second imaging unit 165 can not be specified.

Besides, under the condition that the processing result of the recognition processing unit 612 is that there are many face images with the similarity exceeding the threshold value, these face images are displayed on the display 23 and thus are chosen by the operator at the POS terminal 11.

However, a method for recognizing an object contained in an image is called generic object recognition. With regard to the generic object recognition, various recognition technologies are explicated in detail in the following document. The recognition processing unit 612 carries out the recognition processing of the commodities and persons by utilizing the commodity images and the face images by various recognition technologies, a well-known face authentication technology, etc.

Keiji Yanai, “The current status and future of generic object recognition”, Journal of Information Processing Society, Vol. 48, No. SIG 16 [searched on Aug. 10, 2010], Internet: <URL:http://mm.cs.uec.ac.jp/IPSJ-TCVIM-Yanai.pdf>.

In addition, the technology that the generic object recognition is carried out by dividing the image into areas according to objects is described in the following document:

Jamie Shotton et al., “ ” Semantic Texton Forests for Image Categorization and Segmentations’, [searched on Aug. 10, 2010], Internet: <URL:http://citeseerx.ist.psu.edu/viewdoc/download?doi=10.1.1.145.3036&rep=rep1&type=pdf>.

Accordingly, according to the embodiment, by utilizing the generic object recognition and other technologies to recognize commodities and customers, the recognition processing unit 612 utilizes the first images (commodity images) imaged by the first imaging unit 164 to recognize (specify) the commodities G contained in the first images, and utilizes the second images (face images) imaged by the second imaging unit 165 to determine whether the customers contained in the second images are members or not. Thus, the recognition processing unit 612 can be commonly used, and so the recognition processing unit 612 can be effectively utilized. Besides, the recognition processing unit 612 can be respectively provided for the recognition of the commodities and the customers.

The sales registration unit 613 reads the commodity information of the commodities recognized by the recognition processing unit 612 out of the PLU file F1, and counts the sales amount according to the unit price and the sales points of each commodity. And the sales registration unit 613 records registered sales data such as the commodity name, the commodity ID and the sales amount of the commodity to a sales master file (not shown in Fig.) for a sales registration. And the sales registration unit 613 counts the total sum of the sales amounts of the registered sold commodities.

The preference giving unit 614 gives a preset preference to the customers who are recognized as the members by the recognition processing unit 612. Hereupon, the preference giving content is not specially limited. For example, the reduction and the points can be given according to the total sum of sales amounts of the commodities counted by the preference giving unit 614. Besides, under the condition that the reduction is used as a preference, the given reduction amount is subtracted from the total sum counted by the preference giving unit 614.

Moreover, under the condition that the customers can not be specified by the recognition processing unit 612 when the transaction is finished, the transaction recognition information for recognizing the transaction and the face images input by the commodity imaging apparatus 101 are sent to the member registration terminal 301 by the preference giving unit 614, and thus the transaction recognition information and the face images which are associated with each other are stored in the HDD of the member registration terminal 301. Hereupon, the transaction recognition information can use information such as inherent transaction ID released in each transaction, an inherent cashier number pre-distributed by each POS terminal 11 and the current date and time.

The receipt generating unit 615 generates receipt printing data including given information such as commodity names and unit prices contained in registered sales data by the sales registration unit 613, and the preference content given by the preference giving unit 614, and the printing data is output from the printer 66. Moreover, under the condition that the face images are stored in the member registration terminal 301 by the preference giving unit 614, i.e., under the condition that the customers can not be specified by the recognition processing unit 612, the receipt generating unit 615 generates receipt printing data including the given information contained in the registered sales data by the sales registration unit 613, transaction recognition information of the transaction, and a message for reminding the members to register, and the printing data is output from the printer 66. Besides, the transaction recognition information can be directly output in a plaintext state, and can also be changed into a bar code, a two-dimensional bar code and other symbol bar codes to be output.

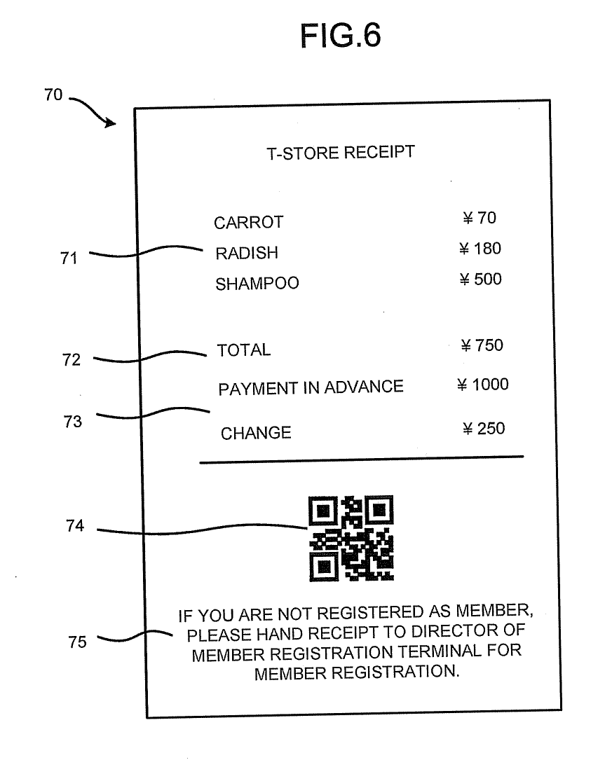

FIG. 6 is a diagram illustrating an example of an receipt output when the recognition processing unit 612 can not specify a customer. As shown in FIG. 6, the receipt 70 includes a registered commodity printing area 71 in which the commodity names and sales prices of the registered sold commodities are printed, a total sum printing area 72 in which the total sum of the commodities is printed, a payment printing area 73 in which the amount paid by the customer and the change are printed, a transaction recognition information printing area 74 in which the transaction recognition information is printed, and a comment printing area 75 in which the message for reminding the members to register and various comments are printed. Besides, in FIG. 6, the transaction recognition information can be changed into a two-dimensional bar code to be printed but not in limitation thereof.

The customer holding the receipt shown in FIG. 6 passes the receipt to the operator operating the member registration terminal 301, and is informed of member registration. In the member registration terminal 301, if the transaction recognition information in the receipt passed by the customer is input by the not shown keyboard, a bar code scanner, etc., the face photo stored by associating with the transaction recognition information is read out of the not shown HDD. Moreover, the member registration terminal 301 builds the association between the read-out face photo and the additionally input member ID, the name, the contact address and other member information, registers them to the store computer 201 and the member management files F2 managed by each POS terminal 11, and executes the member registration of the customers.

Accordingly, under the condition that the customer is not registered as the member, the transaction recognition information printed on the receipt is utilized to read out the imaged face image when the commodity is registered. Thus, the member registration can be carried out by utilizing the imaged face image when the commodity is registered, and consequently, the procedure of the member registration can be smoothly promoted. Besides, the face images registered in the member management file F2 are imaged when the commodities are registered, and not in limitation thereof.

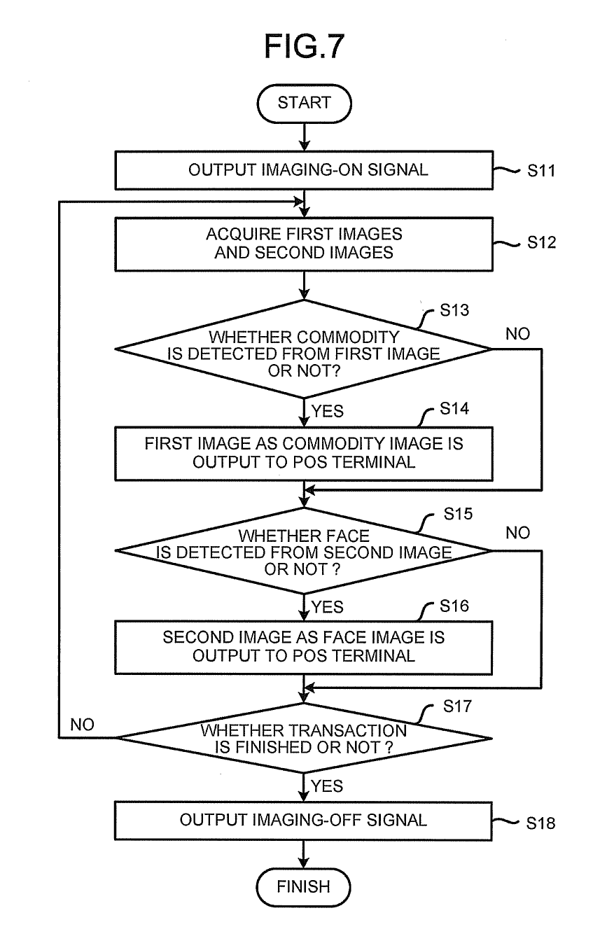

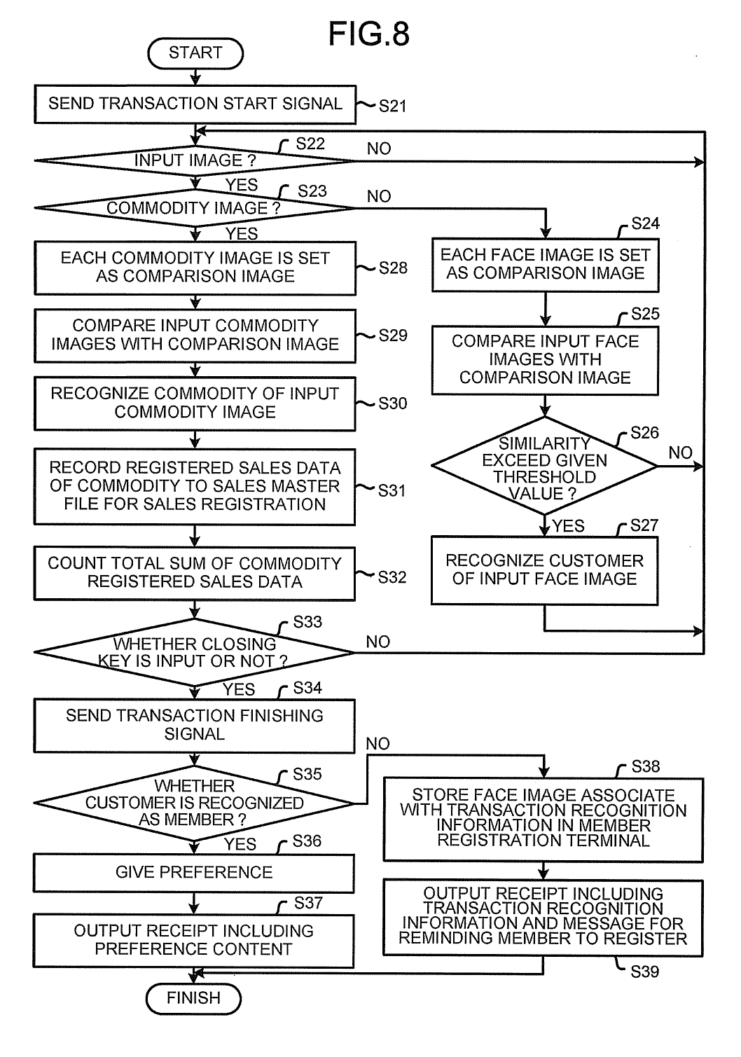

Next, referring to FIG. 7 and FIG. 8, the action of the checkout system 1 is illustrated. Firstly, referring to FIG. 7, the image output processing executed by the commodity imaging apparatus 101 is illustrated. Hereupon, FIG. 7 is a flow chart showing an order of image output processing carried out by a commodity imaging apparatus 101.

The CPU 161 of the commodity imaging apparatus 101 starts carrying out the image output processing when indicating the start of the transaction by utilizing signals from the POS terminal 11. The image acquisition section 1611 outputs pickup turn-on signals to the first imaging unit 164 and the second imaging unit 165, so that the first imaging unit 164 and the second imaging unit 165 start to image (act S11). And then the first images and the second images respectively imaged by the first imaging unit 164 and the second imaging unit 165 are acquired to the RAM 163 by the image acquisition section 1611 (Act S12).

The commodity detection unit 1612 determines whether all or par of images representing the commodities G can be detected in the first images acquired from the act S12 or not (act S13). Hereupon, under the condition that all or part of images representing the commodities G are detected from the first images by the commodity detection unit 1612 (act S13; Yes), the first images as commodity images are output to the POS terminal 11 by the commodity image output unit 1613 (act S14), and then the act S14 turns to the act S15. Besides, in the act S13, all or part of images representing the commodities G are not detected in the first images (act S13; No), the act S13 turns to the act S15 immediately.

The face detection unit 1612 determines whether the images representing the faces of the customers can be detected in the second images acquired from the act S12 or not (act S15). Hereupon, under the condition that the images of the faces of the customers are detected in the second images by the face detection unit 1614 (act S15; Yes), the second images as face images are output to the POS terminal 11 by the face image output unit 1615 (act S16), and then the act S16 turns to the act S17. Besides, in the act S15, the images representing the faces can not be detected in the second images (act S15; No), the act S15 turns to the act S17 immediately.

Next, in the act S17, the CPU 161 determines whether the POS terminal 11 sends signals to indicate the closing of transaction or not (act S17). Under the condition that the closing of transaction is not indicated (act S17; No), the act 517 returns to the act S12 again, and the acts S12-S17 are repeatedly executed until the closing of transaction is indicated. Moreover, under the condition that the closing of transaction is indicated (act S17; Yes), the image acquisition section 1611 outputs pickup turn-off signals to the first imaging unit 164 and the second imaging unit 165 (act S18), so that the pick-up action of the first imaging unit 164 and the second imaging unit 165 are stopped.

Next, referring to FIG. 8, the order of sales registration processing executed by the POS terminal 11 is illustrated. Hereupon, FIG. 8 is a flow chart showing an order of sales registration processing carried out by a POS terminal 11.

Firstly, the CPU 61 of the POS terminal 11 sends the signals for indicating the start of transaction to the commodity imaging apparatus 101 according to the operation of a given key of the keyboard 22 (act S21). Thus, the commodity imaging apparatus 101 starts the commodity reading processing.

Next, the comparison data switching unit 611 waits until the images are input to the commodity imaging apparatus 101 (act S22; No). After the images are input to the commodity imaging apparatus 101 (act 522; Yes), the comparison data switching unit 611 determines whether the input images are commodity images or face images (act 523).

In the act S23, under the condition that the input images are determined as the face images (act S23; No), the face images stored in the member management file F2 are set as comparison images of the recognition processing unit 612 by the comparison data switching unit 611 (act S24). And then the recognition processing unit 612 compares the face images input in the act S22 with the set comparison images (face images in the member management file F2) in the act S24 (act S25) after reading the characteristic quantities of the input face images in the act S22. Moreover, the recognition processing unit 612 determines whether there are comparison images (face images) with the similarity exceeding the given threshold value or not (act S26).

Hereupon, under the condition that there are comparison images with the similarity exceeding the threshold value (act S26; Yes), the recognition processing unit 612 recognizes the customers represented by the face images input in the act S22 as members represented by the comparison images (act S27), and then the act S27 returns to the act S22 again. Moreover, in the act S26, under the condition that there are no comparison images with the similarity exceeding the threshold value (act S26; No), the recognition processing unit 612 determines that the customers can not be specified, and then the act S26 returns to the act S22 again.

Besides, in the one-transaction process, it is better to determine that whether the customers are members or not can be recognized once. Therefore, under the condition that the customers are recognized as members, the following acts S24-S27 are skipped so as to prevent from accidentally carrying out the customer recognition processing. Moreover, by informing the CPU 161 of the commodity imaging apparatus 101 that such content has been recognized, the pickup action of the second imaging unit 165 is stopped, or the acquisition of the second images by the image acquisition section 1611 is stopped, or the action of the face detection unit 1614 and the face image output unit 1615 is stopped.

On the other hand, if the input images are determined as the commodity images in the act S23 (act S23; Yes), each commodity image stored in the PLU file F1 is set as a comparison image of the recognition processing unit 612 by the comparison data switching unit 611 (act S28). Then, the recognition processing unit 612 compares the characteristic quantities read from the commodity images input in the act S22 with the comparison images (commodity images in the PLU file F1) set in the act S24 (act S29). Moreover, the recognition processing unit 612 recognizes the commodities G contained in the input commodity images in the act S22 as the commodities of the comparison images (commodity images) with the similarity exceeding the given threshold value (act S30).

Besides, in the act S29, under the condition that the result of comparison is that there are many commodity images with the similarity exceeding the threshold value, these commodity images are chosen by the operator at the POS terminal 11 by being displayed on the display 23. Under the condition that there is no commodity images with the similarity exceeding the threshold value, a manually chosen commodity picture (GUI) corresponding to the commodity G is displayed on the display 23, and thus is chosen by the operator at the POS terminal 11.

The sales registration unit 613 reads the commodity information of the commodities recognized in the act S30 out of the PLU file F1, and records registered sales data generated based on the commodity information to the sales master file (not shown in Fig) for the sales registration (act S31). And then the sales registration unit 613 counts the total sum of the sales amounts of the commodities sold and registered so far (act S32).

The CPU 61 determines whether the keyboard 22 accepts the input of the key information of the ‘closing’ key or not (act S33, No). Hereupon, under the condition that the input of the ‘closing’ key can not be confirmed, the act S33 returns to the act S22 again. Moreover, under the condition that the input of the ‘closing’ key is accepted in the act S33 (act S33; Yes), the CPU 61 outputs the signals for indicating the closing of transaction to the commodity imaging apparatus 101 via the connecting interface 65 (act S34).

Then, the preference giving unit 614 determines whether the action of recognizing the customers as members is finished or not based on the processing results of the acts S26 and S27 (act S35). Here, under the condition that the action for recognizing the customers as members is finished (act S35; Yes), the preference giving unit 614 gives a given preference to the customers based on the counted total sum in the act S32 (act S36).

Hereupon, under the condition that the given points corresponding to the total sum is used as a preference, the given points are added to the accumulated value of the points stored in the preference information (PLU file F1) of the member. And under the condition that the reduction is used as a preference, the given amount is subtracted from the total sum counted in the act S32.

Moreover, in the receipt generating unit 615, according to the operation, etc. of the operator, after the total sum of the commodities is counted, the receipt including the given items contained in registered sales data registered so far, an item representing the preference content, etc. is output from the printer 66 (act S37), and then the processing is finished.

Moreover, under the condition that the customers cannot be specified in the act S35 (act S35; No), the transaction recognition information of the transaction and the face images input in the act S22 are sent to the member registration terminal 301 by the preference giving unit 614, and thus the transaction recognition information and the face images are stored in the HDD of the member registration terminal 301 by building the association between the transaction recognition information and the face images (act S38). Besides, only one face image needs to be sent to the member registration terminal 301, for example, the newest face image input by the commodity imaging apparatus 101 is sent to the member registration terminal 301.

Moreover, in the receipt generating unit 615, according to the operation, etc. of the operator, after the total sum of the commodities is counted, the receipt including the given items contained in registered sales data registered so far, the transaction recognition information, a message for reminding the members to register, etc. is output from the printer 66 (act S39), and then the processing is finished.

As mentioned above, according to the embodiment, the POS terminal 101 specifies the commodities contained in the images based on the first images (commodity images) imaged by the first imaging unit 164 of the commodity imaging apparatus 101, and determines whether the customers contained in the images are members or not based on the second images (face images) imaged by the second imaging unit 165 of the commodity imaging apparatus 101. Moreover, under the condition that the customer contained in the second images (face images) are members, the given preference is given by the POS terminal 11; and under the condition that the customers are non-members, in order that the procedure of member registration is carried out smoothly, the second images (face images) and the transaction recognition information which are associated with each other are stored in the member registration terminal 301, and the receipt including the transaction recognition information is output.

Therefore, the shop side dose not need to ask the customers to show membership cards, but determines whether the customers are members or not, and the preference is given when the customers are members, and thus the preference can be effectively given to the members. And the customer side does not need to take the membership cards and also does not need to inform the salesperson of membership, thus the convenience is improved.

However, according to the embodiment, the POS terminal 11 can also comprise other components. For example, in FIG. 1, the first imaging unit 164 and the second imaging unit 165 are respectively arranged in order to image the commodity images and the face images, but one imaging unit can also be used for picking up the first images (commodity images) and the second images (face images).

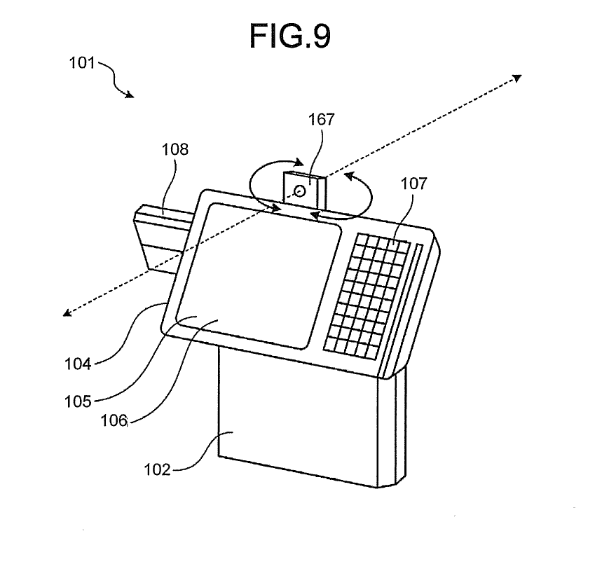

For example, as shown in FIG. 9, a imaging unit 167 capable of switching the pickup direction (refer to a dashed arrow) to the operator side and the customer side of the commodity imaging apparatus 101 can also be arranged to acquire the first images and the second images. Under such condition, the commodity imaging apparatus 101 informs the POS terminal 11 of the switching of the pickup direction (operator side/customer side), or the comparison data switching unit 611 of the POS terminal 11 switches the comparison images of the recognition processing unit 612 according to the pickup direction informed by the commodity imaging apparatus 101.

Besides, in FIG. 9, an example that the imaging unit 167 capable of allowing the pickup direction to face the operator side and the customer side by rotating a main imaging unit body is arranged at the upper part of the display operation unit 104 is illustrated, and the components and the arrangement position are not in limitation of the example as long as the pickup direction faces the operator side and the customer side and the commodities and the faces of the customers can be imaged. However, the imaging unit 167 can also pick up the images towards the operator side and the customer side by a reflecting mirror (lens), etc.

While certain embodiments have been described, these embodiments have been presented by way of example only, and are not intended to limit the scope of the invention. Indeed, the novel embodiments described herein may be embodied in a variety of other forms; furthermore, it is understood by those of ordinary skill in the art that various omissions, substitutions, changes and additions in the form of the embodiments described herein may be made without departing from the spirit of the invention. The accompanying claims and their equivalents are intended to cover such forms or modifications as would fall within the scope and spirit of the invention.

For example, in the embodiment, the commodity imaging apparatus 101 comprises the second imaging unit 165 and the face detection unit 1614, but is not in limitation thereof; the POS terminal 11 can also comprise the second imaging unit 165 and the face detection unit 1614.

Moreover, in the embodiment, the POS terminal 11 and the commodity imaging apparatus 101 are separately arranged, but are not in limitation thereof; however, the functions of the POS terminal 11 and the commodity imaging apparatus 101 can also be realized on one terminal apparatus.

Moreover, in the embodiment, the transaction recognition information and the messages for reminding the members to register are used as an receipt content to be output, but not in limitation thereof, however, the same contents can be output on independent paper except the receipt to be output (printed).

Moreover, in the embodiment, as shown in FIG. 7, the transaction recognition information can be contained in the receipt output under the condition that the customers can not be specified, but not in limitation thereof, however, the transaction recognition information can also be contained in the receipt output under the condition that the customers are members to be output.

Moreover, in the embodiment, a program executed by each apparatus is supplied by being pre-edited into a storage medium (ROM or storage unit) arranged in each apparatus, but not in limitation thereof, however, the same program can be supplied by being recorded in CD-ROM, FD, CD-R, DVD and other recording medium which can be read by a computer through an installable or executable file. In addition, the storage medium is not limited to media which are independent of a computer or grouping system, and also comprises a storage medium which stores or temporarily stores the downloaded programs transmitted via LAN, Internet, etc.

Moreover, in the embodiment, the same program executed by each apparatus can also be stored in the computer connected with the Internet and other networks, and is downloaded via the networks to be supplied, however, the same program can also be supplied or distributed via the Internet and other networks.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a first imaging unit configured to image a commodity as a purchased object;
a commodity recognition unit configured to compare a first image imaged by the first imaging unit with a pre-stored commodity image of each commodity, and recognize the commodity imaged by the first imaging unit based on the similarity with the commodity imaging of each commodity obtained by the comparison;
a second imaging unit configured to image the face of a customer who purchases the commodity;
a member determining unit configured to compare a second image imaged by the second imaging unit with a pre-stored face image of each member, and determine whether the customer imaged by the second imaging unit is a member based on the similarity with the face imaging of each member obtained by the comparison; and
a preference giving unit configured to give the customer who is determined as a member by the member determining unit a given preference when the amount of each commodity recognized by the commodity recognition unit is counted.

2. The information processing apparatus according to claim 1, further comprising:
a storage unit configured to store the second images of the customers which are determined as non-members by the member determining unit in association with the transaction recognition information for recognizing the transaction into a storage medium when the amount of each commodity recognized by the commodity recognition unit is counted; and
an output unit configured to output paper printed the transaction recognition information and a message for reminding the members to register.

3. The information processing apparatus according to claim 1, wherein
the commodity recognition unit and the member determining unit consist of a recognition unit that compares the image of the object as a recognized object with the comparison images that image various objects, and recognizes an object contained in the imaged image based on the similarity with the comparison image of each object obtained by the comparison.

4. The information processing apparatus according to claim 3, further comprising:
a switching unit configured to switch the comparison images for comparing with output image by the recognition unit into the commodity image of each commodity or the face image of member according to the output image of the first imaging unit and the second imaging unit.

5. The information processing apparatus according to claims 2, wherein
the first imaging unit and the second imaging unit is realized by a imaging apparatus.

6. A method, comprising:
imaging a commodity as a purchased object by a first imaging unit;
comparing a first image imaged by the first imaging unit with a pre-stored commodity image of each commodity, and recognizing the commodity imaged by the first image based on the similarity with the commodity imaging of each commodity obtained by the comparison;
imaging the face of a customer who purchases the commodity by the second imaging unit;
comparing a second image imaged by the second imaging unit with a pre-stored face image of each member, and determining whether the customer imaged by the second imaging unit is a member based on the similarity with the face imaging of each member obtained by the comparison; and
giving the customer who is determined as a member a given preference when the amount of each commodity which is recognized is counted.
